(19) United States
(12) Patent Application Publication
(10) Pub. No.: US 2018/0072137 A1
(43) Pub. Date: Mar. 15, 2018

(54) Temporary Plastic Window with Securing Device for Automobiles

(71) Applicant: Pricess Danielle Mitchell, Simpsonille, SC (US)

(72) Inventor: Pricess Danielle Mitchell, Simpsonille, SC (US)

(21) Appl. No.: 15/263,375

(22) Filed: Sep. 13, 2016

(51) Int. Cl. B60J 1/08; B60J 1/00

(52) U.S. Cl. CPC B60J 1/085; B60J 1/006; B60J 1/004

(57) ABSTRACT

A single, thick, durable, flexible, transparent plastic sheet, cut to a pre-selected pattern that replaces a vehicle's missing or damaged side or rear glass windows and is for temporary use or pleasure. Also referred to as a plastic window or sheet or a cosmetic window covering, this plastic sheet fits snugly within the seal of the vehicle's door window or rear window frames. Each plastic window sheet may be secured within the window seal/molding using a sturdy, elongated flat rod (also referred to as the “securing device”) made of a hard, thick plastic and may be inserted into a fold located at the top of each plastic sheet (this step is optional). The plastic sheets may be available with UV protection and/or in an assortment of color options, prints, and tints for privacy, style, fun and fashion.

This inventive plastic window may also be used on the opposite window of the same vehicle making it reusable, recyclable and eco-friendly product.

### BACKGROUND OF THIS INVENTION

Over the years, numerous efforts have been made to provide effective and/or economical alternatives to the expensive repair or replacement of a vehicle's broken or missing side and rear windows. Unfortunately, most designs and existing patents have fallen short of this great achievement. Every day I see multiple vehicles—of all makes and models—that have cut-out cardboard pieces or opaque/dark colored, plastic bags and duct tape (of all colors) covering up the opening left by a vehicle's broken/missing window.

My invention is created to finally solve this ongoing issue. My invention isn't only very practical, but it is also economical; a simple, quick fix; convenient; and can be used as a temporary solution, for privacy or as a fun, fashion statement.

The objective for my invention is to create a fully functional product that's designed to stays in place and give the appearance of a natural window that is always more appealing than using or plastic/trash bags and duct tape. By creating a more natural looking replacement window 1) the vehicle's interior is less likely to be damaged by inclement weather, 2) the vehicle is less likely to be a target for burglary or vandalism and 3) the owner and his/her passengers are less likely to be embarrassed from the use of plastic bags and duct tape which could also be damaging to the vehicle's exterior paint.

Although my research has produced several existing patents that have similar features or capabilities, there are currently no functional and available products on the market at this time.

Existing similar patents include: U.S. Pat. No. 7,090,283 is entitled Cosmetic-plastic Window Covering for Automobile. The '283 patent covers a temporary plastic window replacement for automobiles with an accordion-like design of a which uses a strong, clear adhesive to help support the plastic window covering (which could also create potentially dangerous visibility blocks and distractions for the driver), and has a #2 claim stating its use is for at least one door window being a front door window frame only.

There's also U.S. Pat. No. 3,411,562 which identifies the invention that even though it is a temporary windshield, it contains a series of parallel transfer aluminum reinforcing rods to support the plastic sheet that covers the opening of the windshield frame.

U.S. Pat. No. 6,063,477 explains its invention of the plastic replacement window for automobiles as an apparatus that covers the entire doorframe around the opening of the broken window.

### SUMMARY OF INVENTION

This single, strong, durable, transparent plastic window sheet is designed to give the appearance of a vehicle's actual window when installed properly. This invention is designed to be an economical, temporary relief when the purchase a new window is not immediately available and/or affordable. This plastic window sheet is appropriate for the side door windows and the large back window. In cases where the window frame's seal is loose, the accompanying rod may be inserted into the top fold of the plastic window, then inserted within the top part of the window seal to provide a snug and tight fit before continuing with the rest of the installation process.

What sets this invention apart from prior/existing similar arts is that this plastic window sheet 1) has the optional use of an elongated, flat plastic securing device to secure the sheet in place; 2) the overall design; 3) the installation process; 4) it's customizable to make a perfect fit; and 5) it's reusable, recyclable and green.

For a fashionable and personalized touch, the plastic window designs may be available in an array of colors, emoticons/emojis, logos (i.e.: sports teams, fashion designer, celebrity, etc.), animal prints, textures, seasons, holidays, random print patterns, and more. These design options will make this innovative plastic window the talk of the town.

Additionally:
1) The term “vehicle” and “automobile” are used interchangeably and used in a functional sense indicating general description of any motor vehicle such as: cars, trucks, SUVs, vans, buses, boats, mobile/motor homes, and/or similar mobile driver/passenger structures operated by engine-, solar-, electricity-, and/or battery-powered devices and/or objects that contains one or more glass/plastic/acrylic/other windows or areas where visibility is required.
2) The preferred embodiment of the plastic window is a single sheet that is durable, thick, flexible, and transparent. This material is readily available, and those of skill, or amateur, in the art are familiar (or can become) with working with varying thicknesses.
3) Other materials are available that would be suitable for alternative embodiments of the subject matter of the disclosure (the plastic window sheet). Examples are plexiglass, acrylic, silicone, and/or any other similar transparent and tensile material.
4) The preferred embodiment of the plastic window sheet includes a single, sealed fold with a small opening on one end for the insertion of the securing device. This sealed fold is located at the top of the plastic sheet. The preferred sealing process is folding, heating and melting the edge of the plastic to the body of the plastic sheet. The preferred width will allow for the securing device to be fit snugly.
5) The alternative embodiment of the sealed fold includes: zero (0) folds, two (2), three (3), or four (4) sealed/secured folds that goes along and/or around the plastic window sheet. Henceforth, there could be two folds total, 3 folds total, or 4 folds total around the plastic window sheet. These alternative folds may be at the top, bottom and/or either the right or left sides of the plastic sheet. An alternative embodiment and/or method for sealing the fold is stitching, taping, gluing, and/or similar form, case, use, and/or method for sealing, joining and/or securing folds and/or material.
6) The preferred embodiment of the rod is an elongated, hard and flat plastic member that varies in thickness, width and length to accommodate the plastic window sizes.
7) Alternative embodiments for the rod include (but aren't limited to): an elongated square or circular material constructed of/with/from plastic, rubber, steel, metal, aluminum, wood, or similar material. The alternative embodiment for the insert can be flexible, semi-flexible, stiff, hard, or similar strength, density and/or sturdiness. The optional securing attachments are located on one or both ends of the rod and are in the form of balls, squares, triangles, arrows, flattened shapes (triangles, arrows, rectangles or squares that are flat/flattened), and/or similar forms or shapes. These end members can be located on one end only, on both ends, or at multiple locations spread throughout the length of the rod; or no end pieces or attachments at all on/about the rod.
8) Another alternative embodiment for the rod and/or melted seal is not using the rod at all, but rather a sticky/binding adhesive, tape, cold/hot glue, screws/nails, pins, needles, staples, and/or other similar material used to secure, join and/or seal objects.
9) Another alternative embodiment for securing the plastic window is instead of having a fold(s) and using a rod(s), the edge(s) of the plastic sheet are created and shaped into a hard, thick and flat shape similar to that of the rod. Or another alternative embodiment for securing the plastic sheet is a design whereby the rod is assembled inside the fold, which is then sealed on both ends rather than just one.
10) Those individuals or groups skilled, known or amateur in the art will understand that in any suitable material—for the plastic window covering/sheet, the rod with or without securing attachment, and/or the location of the folds (or not)—now known or hereafter developed, may be used in forming the plastic window, rod, fold, functionality, design, and/or fashionable options described herein.

### A BRIEF DESCRIPTION OF THE DRAWINGS

FIG. 1: is a depiction of the durable, flexible, thick, and transparent plastic window sheet; the sealed fold at the top with a small opening on one end of the plastic while the opposite end is sealed; and the plastic rod inserted within the sealed fold tight and snug.

FIG. 2: is a view of the plastic window covering being installed within a vehicle's front driver door window frame's molding using a small squeegee that has rounded corners, between 3-6 inches long and 3 -4 inches wide and 1-4 millimeters thick.

FIG. 3: is a view of the plastic window sheet almost completely installed. The securing device is fully inserted within the window's molding, and most of the plastic window sheet has been folded and tucked inside and around the frame of the door's window molding. Any excess plastic is removed by cutting it away using scissors or razor.

FIG. 4: depicts the installation complete with the plastic window sheet snugly and securely in place, giving the appearance of a natural window—with no visible creases, folds, or wrinkles.

### A DETAILED DESCRIPTION OF THE INVENTION

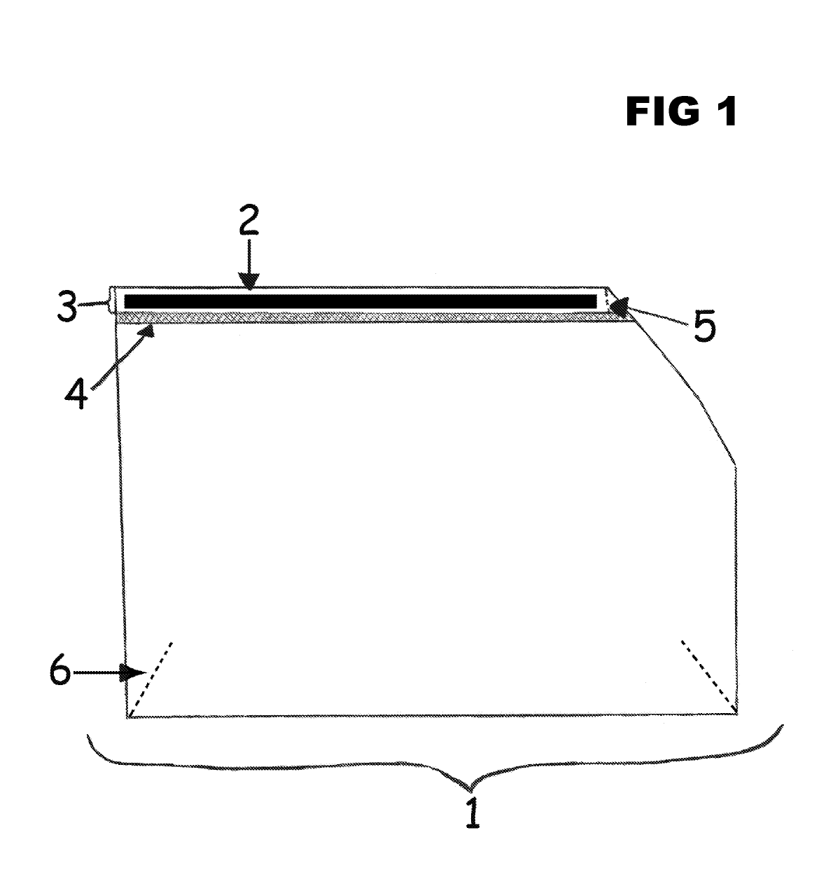

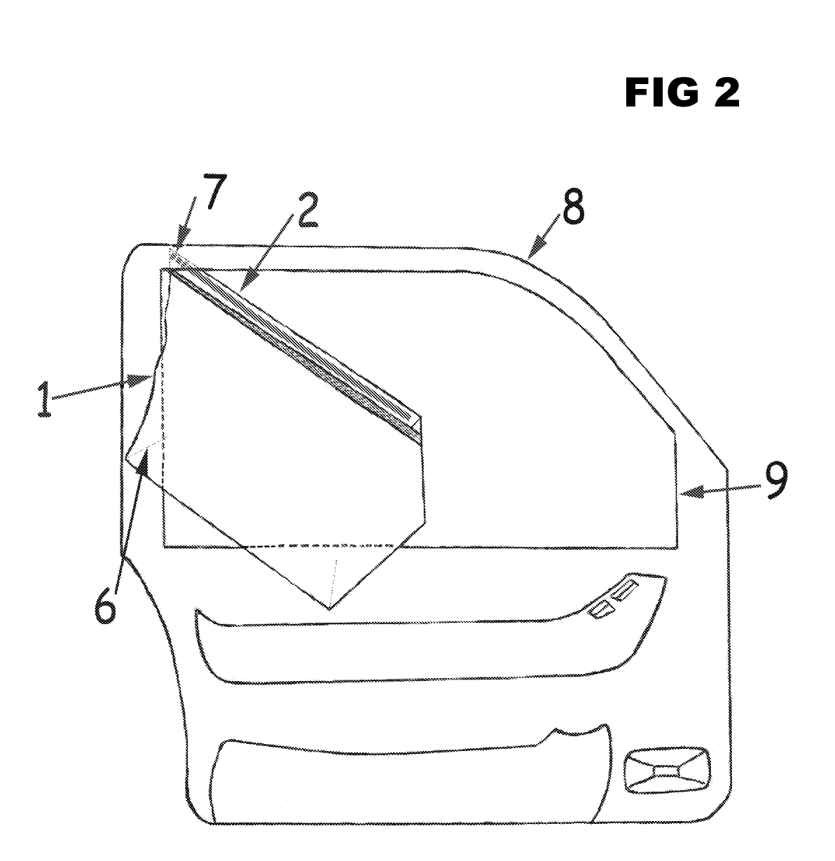

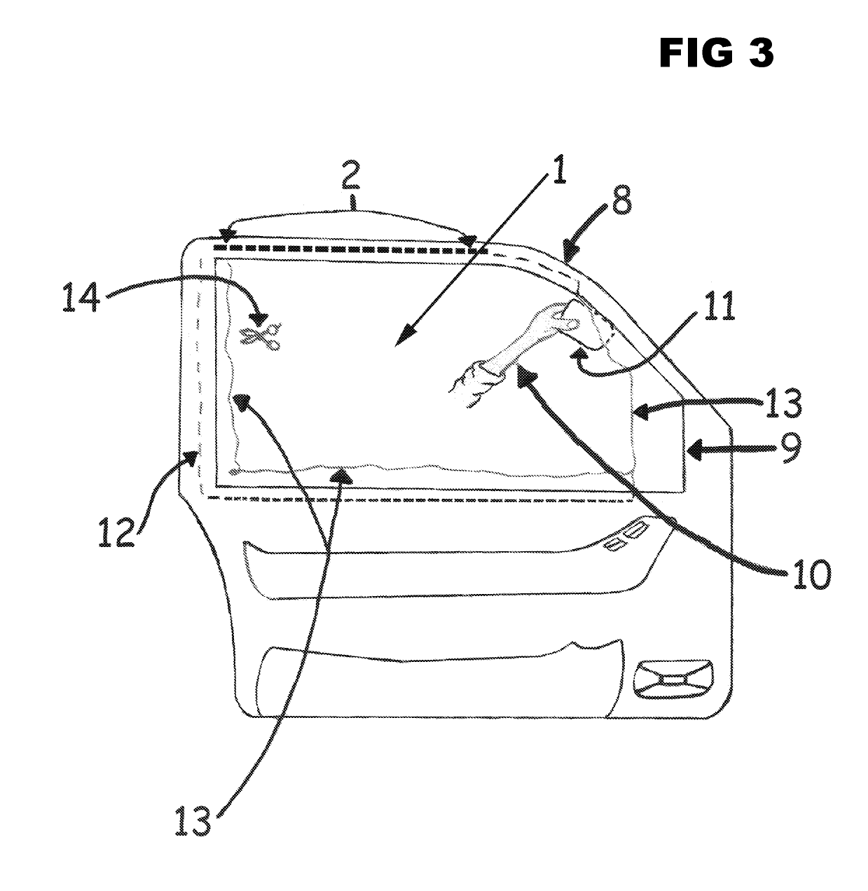

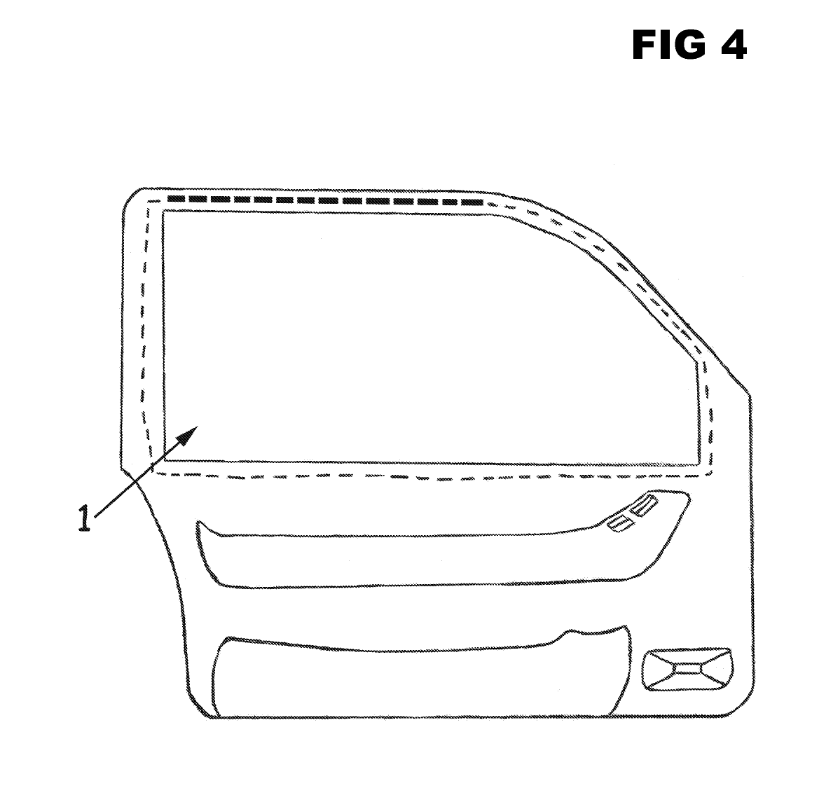

In reference to the drawings, this durable, flexible, strong, thick, and transparent plastic window sheet is a convenient, quick fix for replacing a missing or broken vehicle window and a simple installation process. FIG. 1 shows the plastic window sheet 1; the plastic rod 2; a fold 3 at the top of the plastic window sheet 1 with one end sealed and the other end open 5; the fold's seal 4 created by a heating and/or melting process in order to close and secure the fold 3 and hold the rod 2 in place; the opened end 5 allows for the rod's 2 insertion. The short, pre-cut diagonal slits 6 located at each lower corner helps keep the plastic window sheet 1 from bundling and folding during installation. The installation process in FIG. 2 is quick and easy. FIG. 2 shows the inside of a vehicle door 8 and the first step of the installation process—having one end of the plastic and rod inserted within the molding 7 at the top of the door 8. FIG. 3 depicts the continued installation with the person 10 inserting the plastic window sheet 1 between the window frame's molding 9 using the small, hard squeegee 11 (or a dull plastic knife). Using the squeegee 11, the person 10 guides the remaining exposed rod 2 into the window's molding 9 by firmly pushing the rod up and into the molding until it is no longer visible 2. Next, use the squeegee 11 to firmly tuck and push the remaining plastic window sheet 1 into the sides and bottom 12 of the door window's molding 9—making sure to keep the sheet 1 firm and tight to give a smooth finish. Trim away any excess plastic window sheet 13 using scissors or a razor 14. Done properly, FIG. 4 shows the plastic window sheet 1 as the finished product—which should be tight, smooth and allow for optimal visibility—will have the appearance of a natural window and possibly with a few stylish personalized designs.

I claim:

1) A temporary or personal use replacement window comprising:
a single layer of a thick, durable, flexible, and transparent plastic sheet pre-cut to a pattern that is shaped to have a tight, snug fit and centrally positioned within a vehicle's side or rear window frame's seal/molding;
and designed with a small fold located at the top of the plastic sheet for the optional use of an elongated, hard and flat plastic rod that may be inserted into the open end the fold and used for securing the plastic sheet into the top window molding;
and when installed correctly, the product will give the appearance of a natural window.

2) A temporary or personal use replacement window of claim 1, wherein the plastic sheet's thickness may range between approximately 4 mm and 8 mm to allow for wind/noise suppression quality options while maintaining tensile strength and optimal visual clarity; and may come with UV protection to possibly provide additional protection for the vehicle's driver and passengers.

3) A temporary or personal use replacement window of claim 1, the securing device (or rod) is an elongated, hard, flat plastic that is: 2-5 millimeters (mm) thick; 4 mm-10 mm wide; 10-30 inches (in.) long. The size and thickness of the rod will vary based on the size of the plastic window treatment. For the larger sizes (used for rear windows, for instance), there may be up to four (4) rods included in the packaging to accommodate the wider lengths.

4) A temporary or personal use replacement window of claim 1, wherein the plastic window's designs for personal use in the front driver and front passenger door windows may come with available options consisting of, but not limited to, various transparent tinted colors to choose from.

5) A temporary or personal use replacement window of claim 1, wherein the plastic window's designs for personal use in the backseat passenger door windows and rear window may come with available options consisting of, but not limited to, a variety of transparent: tinted colors; print styles (animal, textures, emojis, emoticons, religious, holiday/seasonal, etc.); logos (sports, fashion designers, product/service brands, celebrities, etc.); charities/non-profits (heart foundation, cancer research, save the children, save the wildlife, etc.); and much more to choose from.

6) A temporary or personal use replacement window of claim 1, wherein the plastic window is reusable, recyclable—thus making it an eco-friendly product.
